(19) United States
(12) Patent Application Publication
(10) Pub. No.: US 2009/0090062 A1
(43) Pub. Date: Apr. 9, 2009

(54) STORM PROTECTION AND SECURITY WINDOW SHUTTER SYSTEM

(76) Inventor: Brian Pandorf, Clearwater, FL (US)

Correspondence Address: DENNIS G. LAPOINTE;LAPOINTE LAW GROUP, PL, PO BOX 1294, TARPON SPRINGS, FL, 34688-1294, US

(21) Appl. No.: 11/867,721

(22) Filed: Oct. 5, 2007

(51) Int. Cl. E06B 9/04

(52) U.S. Cl. 49/50

(57) ABSTRACT

A combination window frame and panel or shutter door system to provide security to premises and to protect the windows from storm wind damage. The frame and shutter door combination is configured to be installed over existing pre-installed windows or configured to be combined as a single window shutter door frame combination to install in window openings on a wall. In an alternative design, the window has a frame adapted to receive a storm panel that covers the window during storms.

### FIELD OF THE INVENTION

The invention relates to protection and security shutter and window systems for use in storm prevalent areas such as where hurricanes are most likely to occur.

### BACKGROUND OF THE INVENTION

There are several shutter systems commercially available; however, most are shutters that when closed do not prevent wind penetration or provide for adequate security when the premises may be vacant. Panels are used but must be installed prior to the hurricane and removed after the hurricane passes. In the latter case, upper level windows of a residence exposes the resident owner to injuries related to climbing ladders and handling panels while on a ladder when wind conditions are present. What is needed is a shutter system that is adapted for existing installed windows or a combination of a shutter and window system that can be easily installed and remains on the residence while providing maximum security.

Existing or current window shutter systems are highly vulverable from a security standpoint as well as from a wind storm standpoint, just from the method in which they are installed. They can easily be damaged or penetrated by wind therein compromising the integrity of the window opening.

The object of the present invention described below is to provide an essentially unitized system that ensures a controlled and simple installation while providing a highly secure window penetration and protection system.

### SUMMARY OF THE INVENTION

In one embodiment of the invention, the invention is a storm shutter system for use with pre-installed windows for providing security to the premises and also for prevention of damage to the window during wind storms. The system comprises a frame configured for mounting around a perimeter of a window opening, a pair of shutter doors hingedly attached to side portions of the frame, and means for latching the shutter doors in a closed position when desired and for unlatching the shutter doors when opening the doors is desired. The shutter doors have a hollow interior portion containing the means for latching and for unlatching the shutter doors. The means for latching and for unlatching the shutter doors include in each shutter door a spring-loaded cable and latch assembly for engaging or disengaging a first mechanical bar that engages with a mating receiver portion in the opposing shutter door and for engaging or disengaging a second mechanical bar that is vertically oriented and engages an aperture in the frame when the shutter doors are in a closed position, and means for disengaging said first mechanical bar from a mating engagement member attached to an outside wall surface when the shutter door is maintained in a normal open position.

The means for disengaging the first mechanical bar from said mating engagement member attached to an outside wall surface adjacent the window opening when the shutter door is maintained in the normal open position further comprises a handle in mechanical communication with the cable and latch assembly. The handle is accessible from an edge of the shutter door juxtapose to the frame.

In another embodiment of the invention, the invention is a storm shutter and window combination system for prevention of damage to the window during wind storms and for providing security as well. This embodiment includes a frame and window combination configured for mounting in a corresponding window opening, with the frame configured to extend inside said window opening a desired distance and to maintain a spaced-apart relationship between the window and a storm panel, and means for mounting the storm panel to the frame, the storm panel being configured to cover the window.

The means for mounting the storm panel to the frame comprises a plurality of threaded studs for engagement with a mating nut. The storm panel also preferably has breaks in it to form a bowed X-shape on its exterior surface. The perimeter potion has a flatten portion exterior to the angular portion that is configured to rest against the surface of the frame surrounding the window being covered and has apertures that align with the studs extending from the frame.

A decorative jam member having a slotted underside configured to engage and cover the threaded studs is preferably included to protect the threaded portions of the storm panel fasteners from weathering effects and to cover them while not in use with such decorative trim pieces.

In still another embodiment, the invention is a storm shutter and window combination system that provide security as well as prevention of damage to the window during wind storms. This embodiment has a frame and window combination configured for mounting in a corresponding window opening, with the frame configured to extend inside the window opening a desired distance and to maintain a spaced-apart relationship between the window and a pair of shutter doors. The pair of shutter doors are hingedly attached to side portions of the frame of the frame and window combination. Also included are means for latching the shutter doors in a closed position when desired and for unlatching the shutter doors when opening the doors is desired. The shutter doors have a hollow interior portion containing the means for latching and for unlatching said shutter doors.

The means for latching and for unlatching said shutter doors comprises in each shutter door a spring-loaded cable and latch assembly for engaging or disengaging a first mechanical bar that engages with a mating receiver portion in the opposing shutter door and for engaging or disengaging a second mechanical bar that is vertically oriented and engages an aperture in the frame when the shutter doors are in a closed position, and means for disengaging said first mechanical bar from a mating engagement member attached to an outside wall surface when the shutter door is maintained in a normal open position. The means for disengaging the first mechanical bar from the mating engagement member attached to the outside wall surface when the shutter door is maintained in the normal open position further comprises a handle in mechanical communication with the cable and latch assembly. The handle is accessible from an edge of the shutter door juxtapose to the frame.

In an optional embodiment for use with shutter doors in the above shutter door embodiments, a door gap overlapping member may be incorporated on a side of the shutter door so that when the doors are in a shut position, the overlapping member will extend past the gap between the doors partially onto the adjacent closed door.

The above embodiments provide for an essentially unitized system that ensures a controlled and simple installation that provides a highly secure window penetration and protection system. The present invention virtually eliminates wall/building openings and provides for maximum protection for the integrity and security of the windows.

Optionally, should a resident have to evacuate a zone during an impending storm and to provide for a higher security state, the shutter door latches and/or handle described herein may be locked from the inside using locking means well known in the art, such as eyelets in the latches with a padlock or cable and padlock combination or pins, etc. These options are not shown the drawings described hereinafter but such methods of locking side by side doors from the inside of a building are well understood by those skilled in the art.

### BRIEF DESCRIPTION OF THE DRAWINGS

In the accompanying drawings,

FIG. 1 is a perspective conceptual view of one embodiment of the present invention mounted in an existing structure window rough opening, which includes a combination shutter and window system;

FIG. 2 is a perspective conceptual view of the embodiment of FIG. 1 with the shutter doors open and the inside cover of the storm shutter missing to expose the latching and unlatching mechanism;

FIG. 3 a cross-section view taken from line 3-3 of FIG. 1 depicting the shutter doors in a closed position;

FIG. 4A is a cross-sectional exploded plan view of a variant of the embodiment of FIG. 1 that allows for the shutter system portion to be pre-installed in an existing structure prior to the window being installed;

FIG. 4B is a conceptual cross-section plan view depicting the assembled embodiment of the embodiment depicted in FIG. 4A;

FIG. 5A is a conceptual cross-section exploded plan view depicting another embodiment of the invention where a shutter system is mounted to an already pre-installed or existing window with the shutters in a closed position;

FIG. 5B is a conceptual cross-section view of the embodiment of FIG. 5A in an assembled form with the shutters in a closed position;

FIG. 6A is a cross-sectional depiction of a variant of the embodiment of FIG. 1 within a single storm panel is used in conjunction with a window with a pre-installed frame adapted to receive and mount the storm panel;

FIG. 6B is a conceptual depiction of the embodiment of FIG. 6A with the storm panel mounted using wing and/or security nuts attached to pre-mounted studs;

FIG. 7A is a cross-sectional depiction of the embodiment of FIG. 6A without the storm depicted and a separated slotted decorative trim or jam member represented by the cross-section view of the jam member that engages the frame studs;

FIG. 7B is a depiction of the embodiment of FIG. 7A with the decorative trim member installed; and

FIG. 8 is an example of a depiction of the shutter being engaged against a wall surface near the window.

### DETAILED DESCRIPTION ON OF THE INVENTION

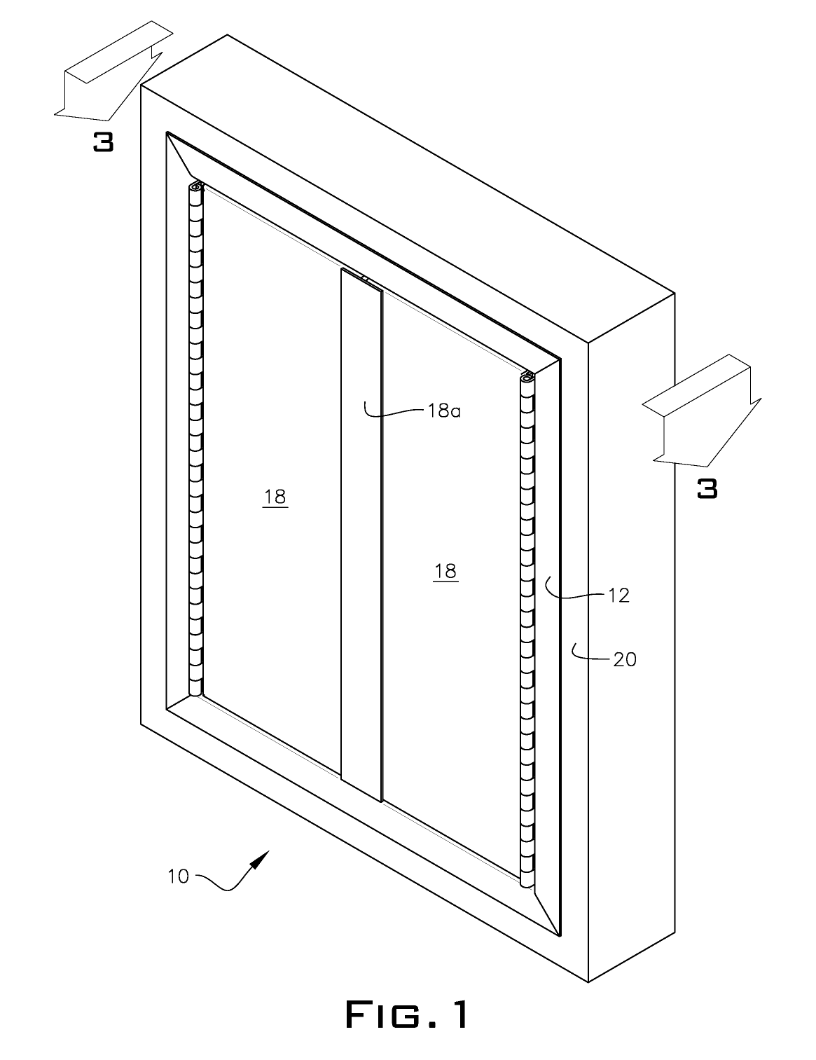

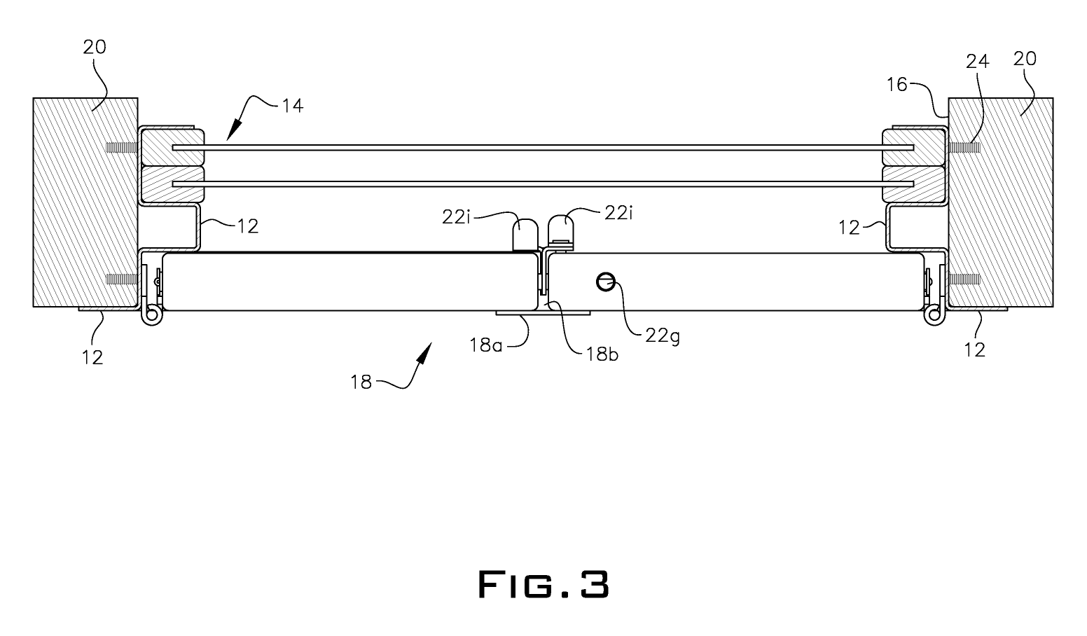

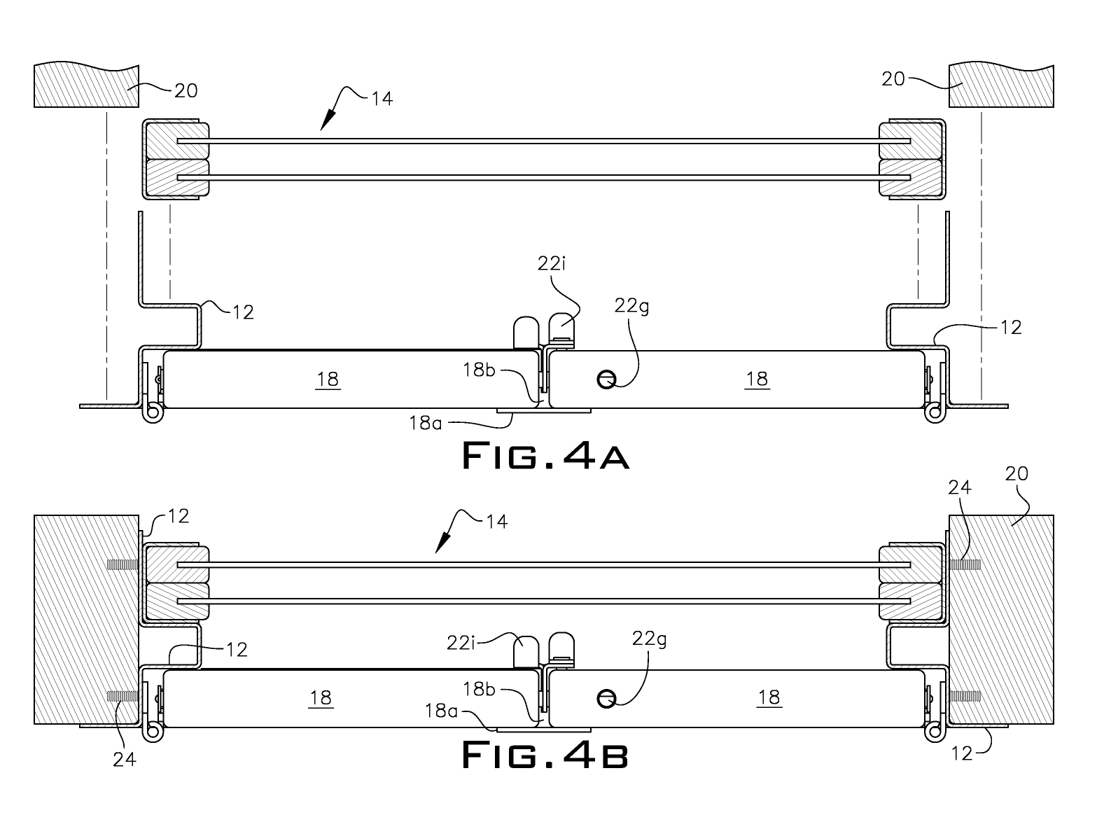

FIGS. 1-3 depict conceptually one embodiment of the present invention mounted in an existing structure window rough opening, which includes a combination shutter and window system, and is generally depicted herein as 10. In this embodiment, the invention is a storm shutter and window combination system 10 for prevention of damage to windows during wind storms as well as for providing security to the premises, comprising a frame 12 and window 14 combination configured for mounting in a corresponding window opening 16, with the frame configured to extend inside the window opening 16 a desired distance and to maintain a spaced-apart relationship between the window 14 and a pair of shutter doors 18. In FIG. 1, the wall in which the window combination system 10 would be installed is represented conceptually by numeral 20.

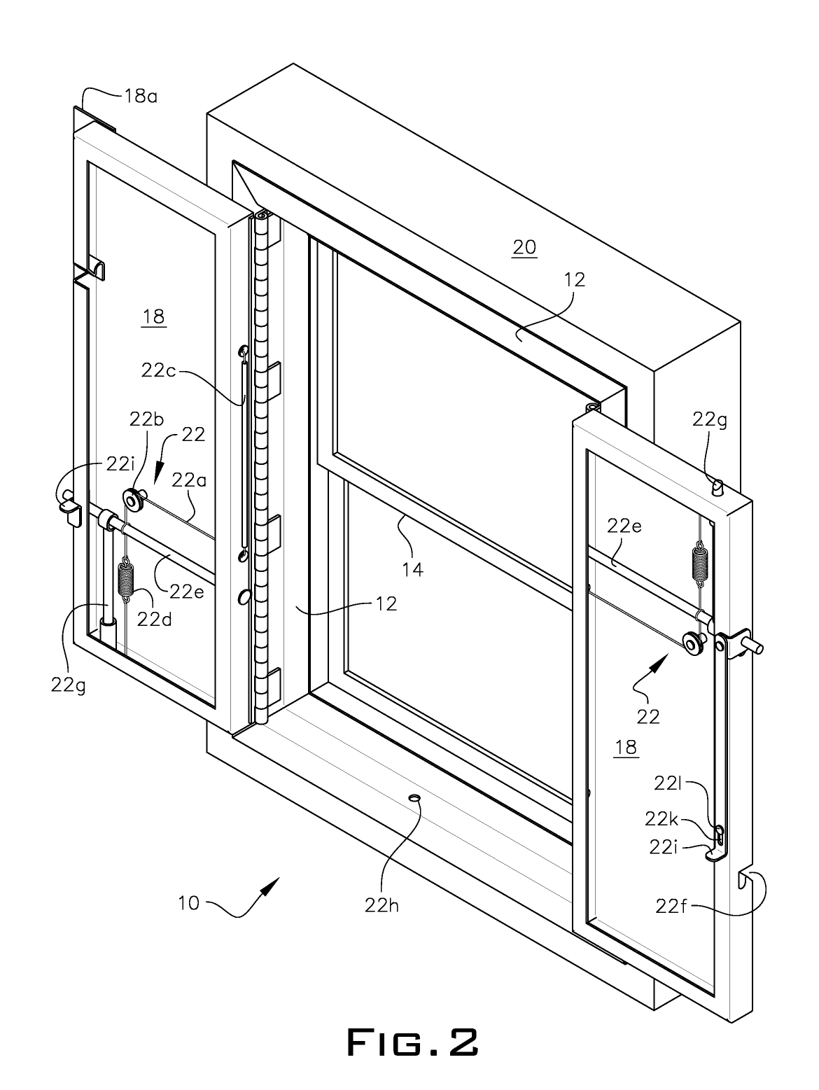

The pair of shutter doors 18 are hingedly attached to side portions of the frame 12. FIG. 2 shows the shutter doors 18 in an open position. Typically the inside surface of the shutter doors 18 would be covered with a panel to hide the internal mechanisms incorporated with the typically hollow interior shutter doors 18, but purposes of illustrating an example of an operative mechanism, the inside panels are not shown in FIG. 2.

Both the inside panel surface and the outside panel surface of the shutters may have embossed, painted or other applied designs or logos representing commercial establishments or characteristics representative of the residents as additional decorative impressions. Examples of such designs or impressions are not shown in the drawings but are well understood. For example, if the shutters were used on a Hilton Hotel establishment, the familiar “H” symbol representative of Hilton Hotels would be visible on the surface of the shutter panels. In fact, this optional feature would apply to any embodiment shown in the drawings.

An example of an operative mechanism is the providing of means 22 for latching the shutter doors 18 in a closed position when desired and for unlatching the shutter doors 18 when opening the doors is desired.

One example of means 22 for unlatching and latching the doors 18 is a spring-loaded cable and latch assembly that includes a cable 22a running over a pulley 22b and a part of which forms or serves as a handle 22c for manipulating the cable 22a. The cable is preferably spring-loaded (see spring 22d anchored at one end to the shutter door 18). The cable 22a is in mechanical communication with a first mechanical bar 22e that engages with a mating receiver portion 22f in the opposing shutter door 18. The first mechanical bar 22e is also in mechanical communication with a second mechanical bar 22g that is vertically oriented and engages an aperture 22h in said frame 12 when said shutter doors 18 are in a closed position. When the shutter doors 18 are in a closed position, levers 22i, which are in mechanical communication with bar 22e, can be manipulated to disengage bar 22e from the mating receiver portion 22f and simultaneously, bar 22g is disengaged from aperture 22h, thereby allowing the opening of the shutter doors 18.

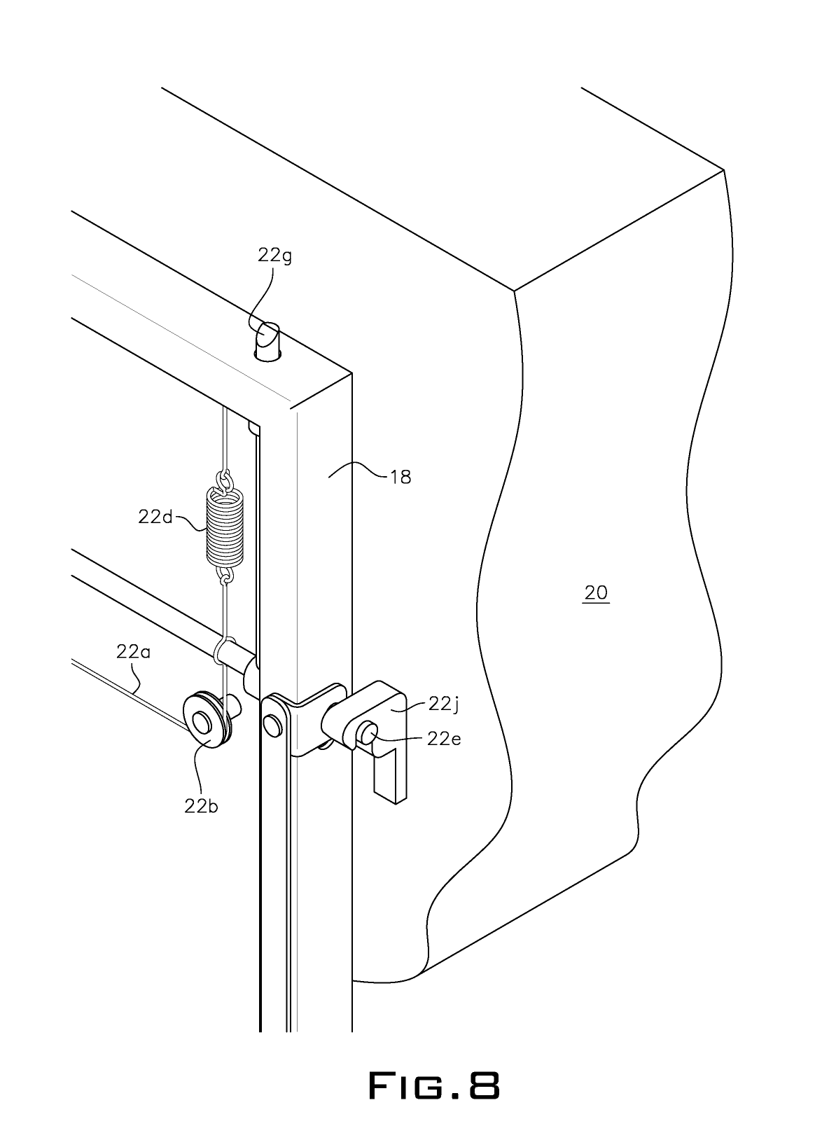

Preferably, provisions are made for means for disengaging the first mechanical bar 22e from a mating engagement member 22j attached to an outside wall surface 20 when the shutter door 18 is maintained in a normal open position As seen in FIG. 8, a receptor member 22j can be shaped to engage and hold the extended part of bar 22e against the wall 20 to maintain the door 18 in an open position. To release the door 18 in order to close the shutters, the cable 22a can be configured to extend outside the shutter door for hand access, such as through an inside edge of the door 18. A part of the cable 22a can thereby be formed as a handle 22c or a handle 22c can be incorporated to be in mechanical communication with the cable 22a, and the manipulating handle 22c can be pulled, thereby lifting the bar 22e to disengage bar 22e from receptor member 22j. As shown in FIG. 2, the right side door 18 lever 22i has a slot 22k and guide pin 22l, which allows lever 22i to be guided up and down.

Typically, the frame 12 of any embodiment described herein can be installed within the window opening of the wall 20 using fasteners 24 as one would any window frame by itself. Fastening locations to the wall of the building can vary depending on the installation or application requirements to the structure.

In an optional embodiment, a door gap 18b overlapping member 18a may be incorporated on a side of the shutter door 18 as conceptually shown in the drawings, so that when the doors 18 are i n a shut position, the overlapping member 18a will extend past the gap 18b between the doors partially onto the adjacent closed door 18.

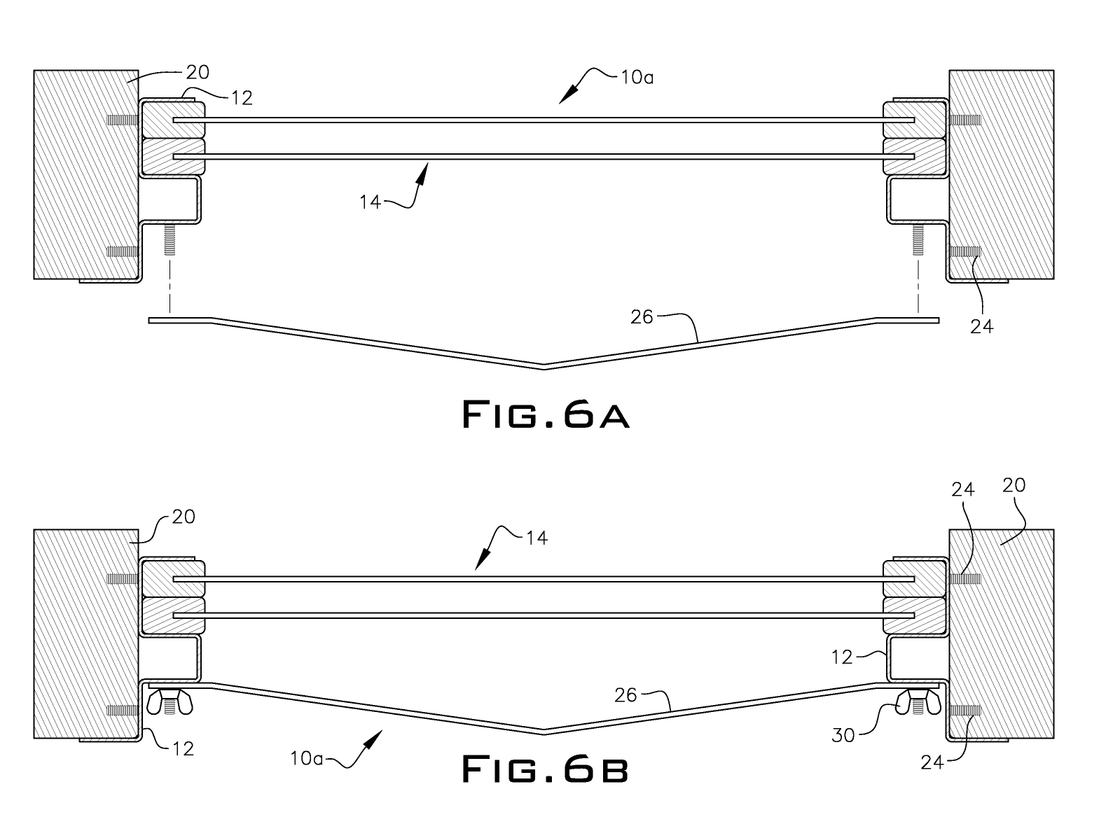

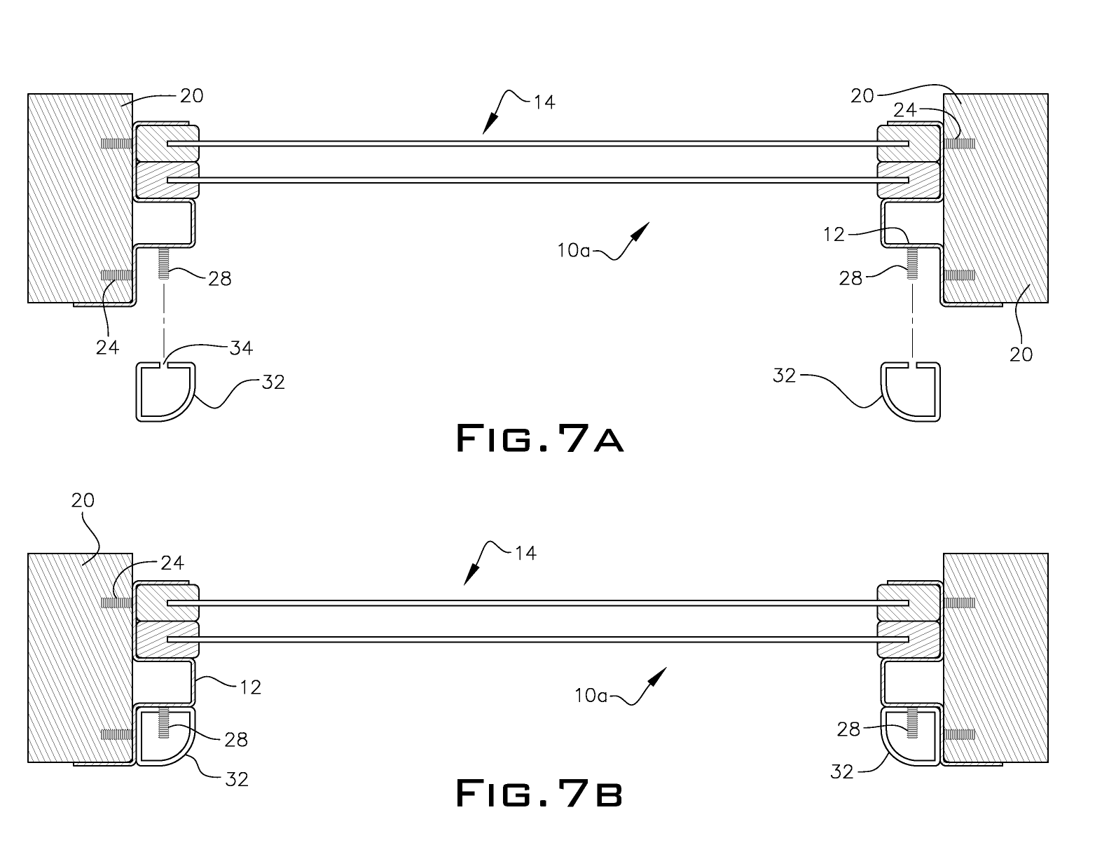

In another embodiment of the invention conceptually depicted in FIGS. 6A, 6B, 7A and 7B and generally enumerated as 10a, the invention is a security and storm shutter and window combination system for prevention of damage to a window during wind storms comprising a frame 12 and window 14 combination configured for mounting in a corresponding window opening, with the frame 12 configured to extend inside the window opening a desired distance and to maintain a spaced-apart relationship between said window 14 and a storm panel 26; and means for mounting the storm panel 26 to the frame 12, the storm panel 26 being configured to cover the window 14. The means for mounting the storm panel 26 to the frame 12 comprises a plurality of threaded studs 28 for engagement with a mating nut 30, such as a wing and/or security nut.

The storm panel 26 preferably has breaks in it to form a bowed X-shape on its exterior surface. The perimeter portion has a flatten portion exterior to the angular portion that is configured to rest against the surface of the frame 12 surrounding the window being covered and has apertures (not shown) that align with the studs 28 extending from the frame 12.

A decorative jam member 32 is preferably included to protect the threaded portions of the storm panel fasteners 28 from weathering effects and to cover them while not in use. The decorative trim pieces 32 have a slotted or apertured underside 34 configured to engage and cover the threaded studs 28.

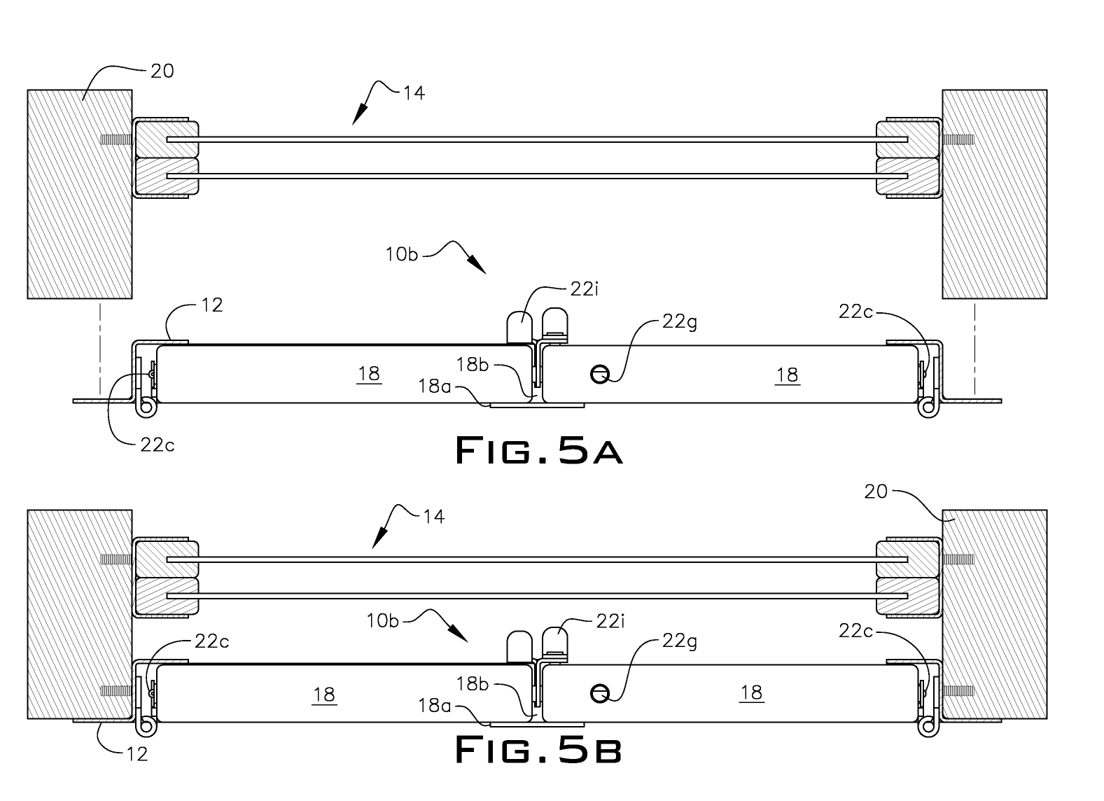

In another embodiment of the invention depicted conceptually in FIGS. 5A and 5B and generally enumerated as 10b, the invention is a security and storm shutter system for use with pre-installed windows 14 for prevention of damage to the window during wind storms. It comprises a frame 12 configured for mounting around a perimeter of a window opening, a pair of shutter doors 18 hingedly attached to side portions of said frame 12, and means for latching the shutter doors 18 in a closed position when desired and for unlatching the shutter doors 18 when opening the doors is desired. The shutter doors 18 have a hollow interior portion containing the means for latching and for unlatching the shutter doors.

The means for latching and for unlatching the shutter doors 18 comprise in each shutter door 18 a spring-loaded cable and latch assembly 22 for engaging or disengaging a first mechanical bar 22e that engages with a mating receiver portion 22f in the opposing shutter door 18 and for engaging or disengaging a second mechanical bar 22g that is vertically oriented and engages an aperture 22h in the frame 12 when the shutter doors 18 are in a closed position, as well as means for disengaging the first mechanical bar 22e from a mating engagement member 22j attached to an outside wall surface 20 when the shutter door 18 is maintained in a normal open position.

The means for disengaging the first mechanical bar 22e from the mating engagement member 22j attached to the outside wall surface 20 adjacent the window opening when the shutter door 18 is maintained in a normal open position further comprises a handle 22c in mechanical communication with the cable and latch assembly 22. The handle 22c can be formed as described above and is accessible from an edge of the shutter door 18 juxtapose to the frame 12.

It should be understood that other latching means are contemplated such as a simple spring loaded system where latches can slide in position or otherwise engage/disengage with the frame in another acceptable manner depending on the preference of the manufacturer or costs. The drawings herein are only intended to depict an example of one preferred method of latching.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. A storm shutter system for use with pre-installed windows for security and for prevention of damage to the window during wind storms comprising:
a frame configured for mounting around a perimeter of a window opening;
a pair of shutter doors hingedly attached to side portions of said frame;
means for latching said shutter doors in a closed position when desired and for unlatching said shutter doors when opening said doors is desired;
said shutter doors having a hollow interior portion containing said means for latching and for unlatching said shutter doors; and
said means for latching and for unlatching said shutter doors comprising in each shutter door:
a spring-loaded cable and latch assembly for engaging or disengaging a first mechanical bar that engages with a mating receiver portion in the opposing shutter door and for engaging or disengaging a second mechanical bar that is vertically oriented and engages an aperture in said frame when said shutter doors are in a closed position, and
means for disengaging said first mechanical bar from a mating engagement member attached to an outside wall surface when said shutter door is maintained in a normal open position.

2. The storm shutter system according to claim 1, wherein said means for disengaging said first mechanical bar from said mating engagement member attached to an outside wall surface adjacent said window opening when said shutter door is maintained in said normal open position further comprises a handle in mechanical communication with said cable and latch assembly.

3. The storm shutter system according to claim 1, further comprising a shutter door edge gap overlapping member extending from along one edge of said shutter door a predetermined distance so as to cover a gap between closed shutter doors.

4. A storm shutter and window combination system for security and prevention of damage to the window during wind storms comprising:
a frame and window combination configured for mounting in a corresponding window opening, with the frame configured to extend inside said window opening a desired distance and to maintain a spaced-apart relationship between said window and a storm panel; and p1 means for mounting said storm panel to said frame, said storm panel being configured to cover said window.

5. The system according to claim 4, wherein said means for mounting said storm panel to said frame comprises a plurality of threaded studs for engagement with a mating nut.

6. The system according to claim 5, further comprising:
a decorative jam member having a slotted underside configured to engage and cover said threaded studs.

7. A storm shutter and window combination system for security and prevention of damage to the window during wind storms comprising:
a frame and window combination configured for mounting in a corresponding window opening, with the frame configured to extend inside said window opening a desired distance and to maintain a spaced-apart relationship between said window and a pair of shutter doors;
said pair of shutter doors being hingedly attached to side portions of the frame of said frame and window combination;
means for latching said shutter doors in a closed position when desired and for unlatching said shutter doors when opening said doors is desired; and
said shutter doors having a hollow interior portion containing said means for latching and for unlatching said shutter doors.

8. The system according to claim 7, wherein said means for latching and for unlatching said shutter doors comprises in each shutter door:
a spring-loaded cable and latch assembly for engaging or disengaging a first mechanical bar that engages with a mating receiver portion in the opposing shutter door and for engaging or disengaging a second mechanical bar that is vertically oriented and engages an aperture in said frame when said shutter doors are in a closed position, and
means for disengaging said first mechanical bar from a mating engagement member attached to an outside wall surface when said shutter door is maintained in a normal open position.

9. The system according to claim 8, wherein said means for disengaging said first mechanical bar from said mating engagement member attached to said outside wall surface when said shutter door is maintained in said normal open position further comprises a handle in mechanical communication with said cable and latch assembly.

10. The system according to claim 7, further comprising a shutter door edge gap overlapping member extending from along one edge of said shutter door a predetermined distance so as to cover a gap between closed shutter doors.
